(19) United States
(12) Patent Application Publication
(10) Pub. No.: US 2010/0255048 A1
(43) Pub. Date: Oct. 7, 2010

(54) Web Material

(75) Inventor: Andreas Schmidt, Duderstadt (DE)

Correspondence Address: GUDRUN E. HUCKETT DRAUDT, SCHUBERTSTR. 15A, WUPPERTAL, 42289, DE

(73) Assignee: MCAIRLAID'S VLIESSTOFFE GmbH & CO. KG, Berlingerode (DE)

(21) Appl. No.: 12/753,199

(22) Filed: Apr. 2, 2010

(30) Foreign Application Priority Data
Apr. 6, 2009 (DE) 10 2009 016 325.5
Jan. 14, 2010 (DE) 10 2010 000 081.7

(51) Int. Cl. A01N 25/34; A01N 59/16; A01N 37/06; A01N 37/10; A01N 33/20; A01N 25/10; A01P 1/00

(52) U.S. Cl. 424/402; 424/618; 514/557; 514/568; 514/727; 424/409; 977/773

(57) ABSTRACT

A web material encompasses a bonded fibrous material web of cellulose material that is made of a layer of cellulose fibers that are press-bonded in sections of the fibrous material web. One or several antimicrobial substances are contained in the fibrous material web. The antimicrobial substances are selected from finely dispersed silver and silver salts, antimicrobial metal oxides, solid inorganic acids, solid organic acids, and biocides.

### BACKGROUND OF THE INVENTION

The present invention relates to a web material in the form of a fibrous material web based on cellulose that contains antibacterial additives and may be used as a bed pad for patients.

Multi-layer absorbent pads or mats are used in food technology and also in the field of hygiene in many applications. For example, they are used in food packagings as a packing insert in order to absorb the liquid that is exuded by meat products. Absorbent hygiene articles in the field of hygiene and in the medical field include pads for diaper changing tables, bed pads for patients, protective pads for the head and for use in shoes and the like. These articles have in common that they can absorb and bind liquid.

In the field of hygiene and in the medical field, hospital beds and patients' beds in general are provided with so-called bed pads that are employed in order to absorb liquids such as urine and ichor. Even when the patient is not in immediate contact with the bed pad that is positioned between the bed sheet and the mattress and these bed pads are regularly exchanged, the risk of infections by microorganisms still exists. As a result of the constant contact with the patient, only separated by the bed sheet, the bed pads are constantly at body temperature and this is an ideal temperature for growth of microorganisms.

The bed pads that are known in the art are in general made of simple nonwoven materials that have no antimicrobial finishing.

The present invention has therefore the object to eliminate or reduce the afore described disadvantages and to provide an absorbent pad that has an antimicrobial finishing, wherein its absorption capability and also its mechanical properties are not impaired by the antimicrobial finishing.

### SUMMARY OF THE INVENTION

In accordance with the present invention, this is achieved in that a web material in the form of a fibrous material web of cellulose (wood pulp), comprising a layer of cellulose fibers that are press-bonded across sections of the layer, wherein the layer is characterized in that one or several antimicrobial substances are contained therein as additive(s).

The web material according to the present invention is suitable for use as a pad in the field of hygiene, for example, as a bed pad.

The antimicrobial substances that, according to the present invention, are used as additives can be selected from any natural or synthetic, inorganic or organic substances having an antimicrobial effect, for example, selected from the group of finely divided silver and silver salts, antimicrobial metal oxides, solid inorganic and organic acids, such as benzoic acid or sorbic acid, biocides including plant-based biocides, such as 2-bromo-2-nitropropane-1,3-diol (bronopol) or polymers. The antimicrobial substances can be used as solid materials or in the form of solutions, emulsions, or suspensions. Preferred is the use of silver and silver compounds that are preferably provided as finely divided particles with a particle size between 1 nm and 500 nm, in particular between 1 nm and 100 nm, for example, nanosilver, or 2-bromo-2-nitropropane-1,3-diol. The antimicrobially acting substances are conventionally contained in a quantity between 3 g and 4 g of substance per square meter of fibrous material web. Examples of suitable commercially available products are Silverpure® (obtainable from Silver Pure), SilverClear® (obtainable from Cilia Solutions Inc.) and Ultra-Fresh SAB-40 (obtainable from Thompson Research Associates).

In order to achieve an action of the antimicrobial substances that is as uniform as possible, it is preferred that these substances are uniformly distributed across the fibrous material web. A uniform distribution of the antimicrobial substances can be achieved, for example, when these substances are already incorporated at the time of processing of cellulose fibers to form the fibrous material web. For example, they can be sprayed on in the form of a solution, an emulsion, or suspension. Solids can be incorporated, for example, by using a hammer mill.

In addition to the antimicrobial substances contained in accordance with the invention in the web material, the web material may contain additional additives. These additives may be selected from super-absorbent polymers, for example, on the basis of carboxy methyl cellulose derivatives or polymers on the basis of (meth)acrylic acid and/or (meth)acrylates, and cyclodextrins or further auxiliaries and fillers, such as titanium dioxide, chalk, kaolin, or plant materials such as spices, aromas and the like. These additional additives can be contained in a quantity of 0.1 to 70 percent by weight, preferably up to 60 percent by weight, relative to the fibrous material web.

The antimicrobial substances as well as the optionally present further additives, fillers and auxiliaries should be present in such quantities in the web material that its structure-providing stability and tear resistance or tear strength still exists for the respective application or use.

In one possible embodiment the antimicrobial substances and optionally present additives are incorporated layer-wise into the fibrous material web. A uniform antimicrobial action is achieved when the substances are distributed as homogeneously as possible.

With the substances and additives contained in accordance with the invention, web-shaped filter materials or absorption materials with a total weight per surface area of 20 to 600 g/m², preferably 30 to 500 g/m², can be produced.

The fibrous material web employed according to the invention can be produced by any suitable method for producing such webs. Preferably, the fibrous material web is produced according to the processing method that is known as the airlaid method. According to the airlaid method, a cotton batting like product of cellulose fibers, i.e., fluff pulp, is laid in an air stream to form a completely random cellulose layer that is subsequently compressed partially in a way essentially known in the art. In one possible embodiment of the present invention, the antimicrobial substances can be applied during the airlaid method step. For this purpose, the active ingredients, when in the form of solutions, suspensions, or emulsions, can be sprayed onto the fluff pulp. It is also possible that these active ingredients are incorporated during the manufacture of the fluff pulp, which is generally obtained by processing cellulose fibers in a hammer mill.

In a preferred embodiment of the present invention, the layer of cellulose fibers (fibrous material web) is provided with embossed areas distributed across the surface area of the web material in which embossed area the cellulose fibers are compressed or press-bonded with one another more strongly than in the other areas and therefore are compressed/press-bonded without adhesives or bonding agents. An embossment pattern with dot-shaped, areal or line-shaped embossment areas is obtained. The fiber layer is thus structured in such a way that the cellulose fibers outside of these discrete embossment areas are present in a loose arrangement on top one another or are only weakly adhering to one another while in the embossment area they form an intimate connection with the neighboring cellulose fibers, respectively. Complete elimination of adhesives and bonding agents for forming the composite of cellulose fibers enables a simple and complete recycling of the web material. In the embossment areas the fibers do not simply adhere to one another. Instead, the pressure loading causes neighboring cellulose fibers in these embossment areas to be connected (bonded) to one another fixedly and intimately. The embossment provides that the surface area of the web material on at least one side has a three-dimensional structure. The embossment area can have any desired shape, for example, it may represent lettering or a symbol.

In a further embodiment of the present invention, the additives can also be applied, for example, by spraying or printing, onto the web material that is already section-wise compressed or compacted.

In applications in which the strength of the fibrous material web is not sufficient, a further reinforcement can be provided by additional melt fibers and/or bonding agents (binders) or by means of water needling.

For the adsorption and/or absorption behavior of the web material it may be advantageous when the cellulose fibers of the layer are unbleached or bleached only minimally or are dyed.

In a further possible embodiment of the present invention, the web of fibrous material is comprised of individual partial material webs. The density of the individual partial material webs may be different. For example, they can be connected or bonded to one another by a bonding agent (binder). This embodiment enables the variation of the properties of the web material according to the present invention.

For increasing the tear strength of the web material, according to another embodiment of the present invention, it can be provided with a reinforcement web that is arranged between at least two partial material webs of fibrous material and is bonded or connected fixedly with these partial material webs of fibrous material to form the fibrous material web. As a reinforcement web in particular a flexible web is suitable wherein a net structure with a mesh size between 15 and 50 square millimeters is especially preferred. The reinforcement web can be, for example, a woven fabric, a knit fabric, or a nonwoven web. Depending on the field of application, the reinforcement web can also be a continuous film provided in the pressure areas with perforations that are torn and/or in the form of a melted hole. The selection of material for the reinforcement web depends in general on the field of application of the web material to be produced, for example, is based on the demands on tear resistance or tear strength.

For further increasing the strength, i.e., tear strength and/or stiffness, the web material according to the invention can be provided on one side of the web material, or on both sides, with a flat cover layer. This flat material can be in particular a textile, non-woven or film-like material but also tissue. The cover layer can be glued or adhesively connected to the fibrous material web and/or fused thereto and/or mechanically bonded thereto.

The web material according to the invention is produced usually in the form of rolls. The material is preferably so flexible that three-dimensional bodies can be formed of it. In a possible embodiment of the present invention, it is pleated, i.e., folded in zigzag shape.

The web material according to the invention is in particular suitable for use in the field of hygiene, for example, as a bed pad, a pad for diaper changing tables, an incontinence product, a female hygiene product, disposable diaper, or a product for treatment of wounds. A further field of use is food packaging, in particular packing fresh meat, fish, cheese, etc. In this field, further additives such as adsorption agents that in particular act as odor inhibiting agents are used. Further suitable additives are super-absorbent polymers that can absorb bodily fluids.

### BRIEF DESCRIPTION OF THE DRAWING

FIG. 1 is a large-scale partial section view of the web material according to the invention.

FIG. 2 is a partial section view of a multi-layer web material.

FIG. 3 shows the web material according to the invention in a perspective view from above.

### DESCRIPTION OF THE PREFERRED EMBODIMENTS

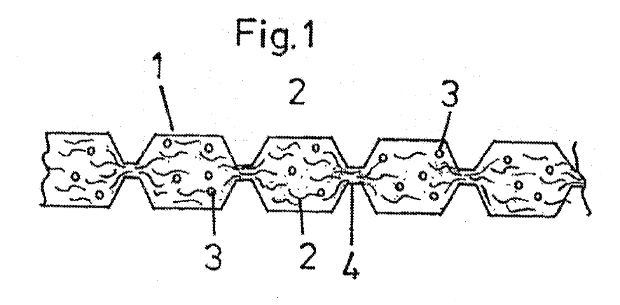

FIG. 1 shows a partial section view of the web material according to the invention. The fibrous material web 1 is comprised of a high proportion of cellulose fibers 2 into which absorption agents 3 are incorporated.

The cellulose fibers 2 are compressed within the embossment area 4 and in this way connected or bonded to one another. The embossment areas 4 are positioned on the topside side and bottom side opposite one another so that in the respective embossment area 4 only a narrow stay of bonded cellulose material remains. The other areas of the layer 1 between these embossment areas 4 have loosely layered cellulose fibers. An intimate connection of bonding between the cellulose fibers does not exist in these areas.

The layer 1 that determines the absorption behavior for the substances to be removed is comprised of cellulose fibers 2 with integrated absorption agent 3 as well as optionally further additives. In the illustrated embodiment, the material web 1 has in the embossment areas 4 the shape of truncated pyramids or truncated cones wherein the angle of the slants formed by these shapes is preferably between 10 degrees and 45 degrees.

As a cellulose material for the fibrous material web 1 mass-produced and inexpensively available material can be employed. Preferably, so-called fluff pulp is used that is characterized by excellent bonding behavior; this improves mechanical strength of the material web in regard to vertical tensile forces.

When manufacturing with a continuous method, the fibrous material web that will later on form the layer 1 is produced from loosely laid fill that is laid in an air stream and comprised of cellulose fibers 2 of wood pulp and antimicrobial substance(s) and optionally incorporated further additives. For producing a standardized wood pulp material for use in the instant invention, commercially available renewable wood products can be employed.

The method of airlaying a cellulose fill as a starting material for the layer 1 enables dry processing of the cellulose fibers 2 and thus in the subsequent embossment step of the multi-layer web between two structured rollers an excellent compaction or compression of the cellulose fibers in the discrete embossment areas 4. Outside of the embossment areas 4 the fibers are loosely resting on one another; this improves the absorption behavior for liquids to be absorbed as well as the flexibility of the layer 1.

The manufacture is realized from a material web which is produced in a continuous process. In air-supported laying, first the cellulose fibers and the absorption agents 3 as well as optionally further additives for forming the layer 1 are laid. Subsequently, in a calander with two structured calander rollers the embossed areas 4 are produced. A possible manufacturing process is disclosed, for example, in European patent 1 032 342.

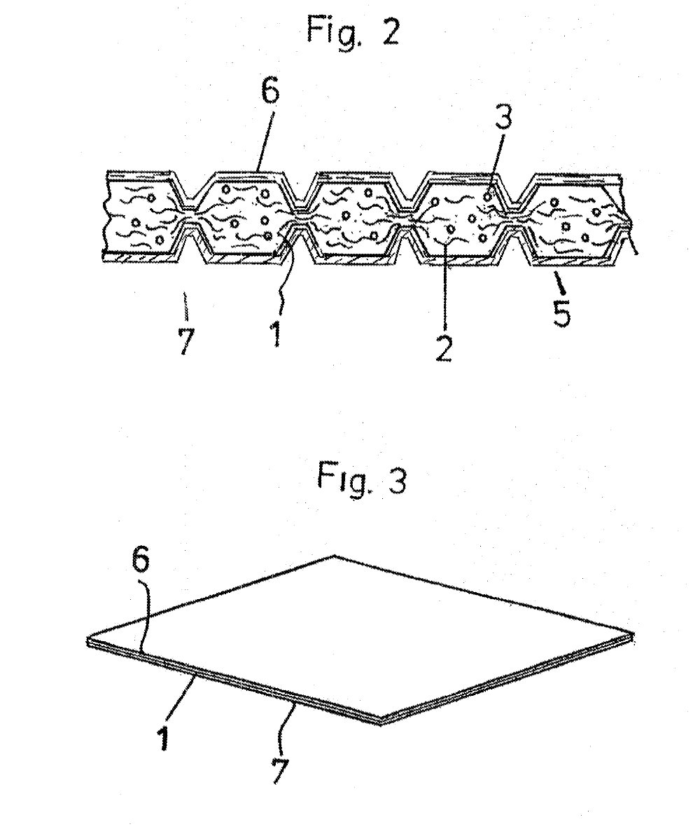

The cellulose web 1 can be further processed in subsequent method steps to a multi-layer web as illustrated in FIG. 2. In these further continuous steps the cover layer 6 on top and the base layer 7 at the bottom are arranged and then connected or bonded to the core layer 1 of cellulose fibers 2. The thus produced web material 5 can subsequently be used and can be cut to size for the respective application directly on site or immediately subsequent to its manufacture or formed into a three dimensional body.

Alternatively, the multi-layer web material can also be produced in that the cover layer 6 or the base layer 7 is first used as a support layer. Onto this support layer 6 or 7 the loose fill of cellulose fibers 2 and optionally added antimicrobial substances 3 and further auxiliaries and additives 3 are laid in an air stream. Subsequently, this arrangement comprising support layer and loose fill are together passed through the structured rollers of the calander. Alternatively, prior to this, i.e., before the final pass through the calander, the other one of the two layers 6, 7 which is thus not the already used support layer, can be placed onto the cellulose layer 1.

The further layers can be subsequently applied by methods known the art. When the additional layers are subsequently applied, they can have any suitable surface structure, for example, they can have a smooth surface.

In FIG. 3 in a view from the top at an angle the web material is shown which in the embodiment is comprised of three layers 6, 1, 7.

The lowermost layer serves as a base material 7 and the upper layer as a cover layer 6. When the web material is used as a bed pad, the cover layer 6 should be permeable for the bodily fluids to be absorbed. The base material 7 in this application is preferably impermeable in order to prevent that bodily fluid(s) will pass into the mattress. The base material 7 can be, for example, formed by a film.

Above the base material 7, a layer 1 of cellulose fibers is provided that in this embodiment rests flat on (is in full areal contact with) the base layer 7. The layer 1 contains antimicrobial substance(s) and optionally also further additives. This layer 1 is permeable for bodily fluids and the bodily fluids are absorbed by the cellulose fibers of layer 1. When used as an absorbent material, the layer 1 exhibits high absorption capability for liquids, in particular for bodily fluids. In the illustrated embodiment, a cover layer 6 is resting flat on the layer 1 (is in full areal contact with layer 1) and covers the layer 1 completely. The cover layer 6 serves additionally as a protection of the cellulose web with regard to damage and destruction during use.

In order to be able to differentiate the base material 7 and the cover layer 6 more easily, it has been found to be advantageous to mark one or both sides of the web material. In this way, for example the health care personnel, even when under great stress, can recognize quickly which side is up and which is down. A special advantage of providing the sides with a color marker or identifier is that the marking will be visible through the bed sheet. When changing the bed sheets, the health care personnel will see that beneath the bed sheet a bed pad is positioned that must be removed before the bed sheets are being laundered.

The web material according to the invention can be enclosed by further layers that are larger than the cellulose layer 1 and the optionally arranged layers 6 and 7; the further layers are connected to one another without engaging the web material. These further layers thus form an envelope for the web material. They can be made from textile, non-woven or film-like material or tissue.

The specification incorporates by reference the entire disclosure of German priority document 10 2009 016 325.5 having a filing date of Apr. 6, 2009.

While specific embodiments of the invention have been shown and described in detail to illustrate the inventive principles, it will be understood that the invention may be embodied otherwise without departing from such principles.

What is claimed is:

1. A web material comprising:
a bonded fibrous material web of cellulose material, comprised of a layer of cellulose fibers that are press-bonded in sections of the fibrous material web;
one or several antimicrobial substances contained in the fibrous material web.

2. The web material according to claim 1, wherein the antimicrobial substances are selected from the group consisting of finely dispersed silver and silver salts, antimicrobial metal oxides, solid inorganic acids, solid organic acids, and biocides.

3. The web material according to claim 2, wherein the organic acids are benzoic acid and sorbic acid.

4. The web material according to claim 2, wherein the biocides are plant-based.

5. The web material according to claim 1, wherein the antimicrobial substances are selected from the group consisting of finely dispersed silver and silver salts, benzoic acid, sorbic acid, and 2-bromo-2-nitropropane-1,3-diol.

6. The web material according to claim 1, wherein the antimicrobial substances have a particle size between 1 nm and 100 nm.

7. The web material according to claim 1, comprising additives selected from the group consisting of super-absorbent polymers, cyclodextrins, auxiliaries and fillers.

8. The web material according to claim 7, wherein the fillers are selected from the group consisting of titanium dioxide, chalk, and kaolin.

9. The web material according to claim 1, wherein the additives are contained in a quantity of 0.1 to 70 percent by weight relative to a total weight of the cellulose fibers.

10. The web material according to claim 7, wherein the additives are incorporated layer-wise into the fibrous material web.

11. The web material with according to claim 7, wherein the additives are incorporated homogeneously into the fibrous material web.

12. The web material according to claim 1, wherein the antibacterial substances are incorporated layer-wise into the fibrous material web.

13. The web material according to claim 1, wherein the antibacterial substances are incorporated homogeneously into the fibrous material web.

14. The web material according to claim 1, having a total weight per surface area of 20 to 600 g per square meter.

15. The web material according to claim 1, having a total weight per surface area of 30 to 500 g per square meter.

16. The web material according to claim 1, wherein the fibrous material web is produced by air-laying.

17. The web material according to claim 16, wherein the cellulose fibers of the fibrous material web are compressed with one another in an embossment pattern of dot-shaped or line-shaped embossment areas and wherein in the embossment areas as a result of high pressure application the cellulose fibers are press-bonded without an adhesive or binder.

18. The web material according to claim 17, having at least one side with a surface having a three-dimensional structure.

19. The web material according to claim 1, wherein the fibrous material web is comprised of individual partial material webs, wherein the individual partial material webs differ in density.

20. The web material according to claim 19, comprising a flexible reinforcement wherein between two partial material webs the flexible reinforcement is positioned that is connected to the partial material webs to form the fibrous material web.

21. The web material according to claim 1, comprising a web of textile, nonwoven or film-like material applied to at least one side of the web material.

22. The web material according to claim 1, wherein the fibrous web material is reinforced with additional melt fibers and/or a binder and/or by water needling.

23. The web material according to claim 1 in the form of a bed pad or a wound pad.
